(19) United States
(12) Patent Application Publication
(10) Pub. No.: US 2024/0244139 A1
(43) Pub. Date: Jul. 18, 2024

(54) BINDING MULTIPLE AGENT-MATCHING ALGORITHMS AND THE DYNAMIC SELECTION THEREOF

(71) Applicant: Avaya Management L.P., Durham, NC (US)

(72) Inventors: Anirudh Patel, Pune (IN); Joaquin Omar Alvarado, Eatontown, NJ (US); John A. Young, Buntingford (GB); Prajna Dev, Pune (IN)

(21) Appl. No.: 18/097,699

(22) Filed: Jan. 17, 2023

(51) Int. Cl. H04M 3/523

(52) U.S. Cl. CPC H04M 3/5233; H04M 3/5234

(57) ABSTRACT

Making the best customer-agent matching decision to engage in a communication to resolve a work item is a primary objective of any contact center. In addition to or as an alternative to standard routing decisions, a real-time agent-matching module is selected from a pool of agent-matching modules, each real-time agent-matching module being unique in its ability to match a resource (e.g., agent) to a customer. The real-time agent-matching modules may differ from one another in terms of information gathered and/or utilizing logic unique to that particular agent-matching module. An orchestration layer is provided to select a single agent-matching module or a series or parallel number of agent-matching modules to select a resource and connect to the customer.

### FIELD OF THE DISCLOSURE

The invention relates generally to systems and methods for dynamically configuring a contact center and particularly to selecting a particular routing logic based on a real-time state of the contact center.

### BACKGROUND

Contact centers connect calls, or other forms of communication (e.g., text messages, video, etc.) conducted over a network, between a customer and an agent selected to resolve a work item, such as to gather information, provide information, or perform a task. Traditional contact centers match incoming calls to agents based on prior knowledge of the customer, such as knowledge obtained from static sources, e.g., a customer resource management (CRM) database, along with any other dynamic data collected during the start of the call, such as customer-provided answers to general questions or a selection of a particular menu option. Calls are also routed to a particular agent based on the customer's requests, the agent's availability, and the skills assigned to the agent.

Prior art contact centers often utilize systems to fetch/mine fine-grained details of customers and agents from various sources (e.g., social networking sites) to create and store predefined customer/agent profiles, as per their rich attributes collected, and in order to provide a better customer-to-agent match. However, even with such advancements, contact centers still rely on pre-mined attributes (e.g., attributes of customers and agents) stored beforehand which, ultimately, result in attribute-based customer-agent matching.

### SUMMARY

Despite the improvements, prior art contact center systems still lack a better way to map required skills with different agent-matching algorithms and mechanisms to dynamically select one of the customer-to-agent matching algorithms. These prior art systems lack the ability to make on-the-fly modifications to their decision-making methodology and particularly lack the ability to consider numerous vital and real-time contact center routing conditions along with attributes for agent matching.

These and other needs are addressed by the various embodiments and configurations of the present invention. The present invention can provide a number of advantages depending on the particular configuration. These and other advantages will be apparent from the disclosure of the invention(s) contained herein.

As a general introduction, and in one embodiment, multiple agent-matching algorithms, or modules thereof, are selectively bound together via a static and/or dynamic configuration or an orchestration layer for selection on-the-fly (e.g., in real-time) for use to generate a best agent-customer match. The orchestration layer may be deployed as an integral part of a networking or computing component, such as a switch (router), or can reside as a stand-alone module or device or component thereof.

In another embodiment, each agent-matching module registers itself with an orchestration module (within a router switch or a separate intermediate module) that assigns and binds them with a unique identifier for routing. The orchestration layer selects a desired agent-matching module or applies a cascading rule to get a best agent match and may follow a static configuration or dynamic configuration. Static configurations may be performed in advance, automatically, and/or manually, based on the mapping of agent skills with respect to agent-matching modules (e.g., unique vs. overlapping skills). Dynamic configuration may be determined by a number of contact center routing conditions and metrics such as: call and agent surplus, agent selection time, agent proficiency level, predictive wait time in queue for skill or attribute set, backlog queues, average handle time (AHT) per agent indicator, call success rate with respect to matcher modules, matcher modules' occupancy and resource usage, etc.

In another embodiment, utilizing a cascading mechanism, the orchestration module is presented with a best agent match for a requested skill or attribute set, by executing and running through all available agent matcher algorithm modules, thereby injecting each module's output (agent subset) to a successor module. The successor module causes the last module in the list to select/provide (from the given subset) the best agent for the required skill or required attribute set.

The orchestration and agent-matching modules comprise the metrics and/or metadata required to select one or all matcher module(s) and run the corresponding agent-matching algorithms. The agent-matching modules differ in one or more aspects, which may include differing data collection processes, storage of data, use of fine-grained data of agent and customers as well as fine-grained data of the system (e.g., call rate, successful/failed calls, resource usage, etc.).

In another embodiment, a configuration is provided to define a configuration wherein each of the modules is assigned a group of skills which can be overlapping or unique, but preferably the configuration identifies and omits any module that is an identical copy of another module. The skills act as a broad categorization for the type of domain/calls the contact center services. Administrators can decide beforehand which unique skills are best suited for an agent-matching module and/or provide an overlapping skills configuration, leaving the decision to be made during call routing by the orchestration layer itself. For each of these skills, there could be multiple agents tagged within the same agent-matching module or across agent-matching modules.

The contact center supervisor (automated and/or human) at any point in time may further configure the orchestration layer manually to use and apply agent-matching modules selectively or set the cascading mechanism for any of the routing conditions defined above. The configuration may be based on a metric determined from monitoring the contact center and whether the metric exceeds a previously determined threshold.

In another embodiment, a datastore is disclosed that is accessible to the orchestration layer and that provides data utilized for decision making. The datastore may intermittently, continuously, or on an ad hoc basis save/update contact center variable metrics, including but not limited to:
Call success rate, which may be an overall rate or a rate for a given skill with regard to an agent-match module, e.g., the call success rate for an attribute match module versus an artificial intelligence (AI) match.
Matcher modules' agent selection time under various busy/load scenarios.
An efficiency indicator based on average handle time (AHT) calculated per agent.
Customer feedback for a particular agent (for a skill and/or attribute set) given by a matcher module.
Agent-matching module system metrics such as occupancy/resource usage/pending match, requests/backlog queue size, etc.

In another embodiment, the orchestration layer selects an on-the-fly agent-matching module or applies agent-matching module cascading to get the best agent match. Such threshold triggers could be applied to any of one or more of the data/metrics residing inside the datastore. Additionally or alternatively, the selection of on-the-fly agent-matching modules or application of agent-matching module cascading may be automatically triggered based on exceeding a predefined threshold set by the orchestration layer.

In another embodiment, when a call is received from a customer for initial processing, initial processing may be simply holding the call or holding the call and providing information (e.g., on-hold announcements). The information may include accessing any caller ID information and looking up the caller in a CRM database to gather general or likely related information (e.g., caller ID is associated with a high-value customer, caller ID is associated with a recent purchase of a particular item, etc.). In addition or alternative to the information gathered from caller information, the call may be initially processed by an automated resource such as an interactive voice response (IVR) component or keypad (e.g., dual-tone multi-frequency (DTMF)) responses to prompts. A broad categorization may be performed, such as to identify the primary skill required to serve the customer and complete the work item. The orchestrator module determines how (e.g., which agent-matching modules to use and which to not use) to get the best agent-customer match for the skill or attribute set from the agent-matching modules. The orchestrator module's decisions may be determined from one or more of skill set configurations, one or more dynamic call routing conditions, datastore variable metrics (as indicated above), and/or the occurrence of a threshold condition(s).

Exemplary aspects are directed to:
A method for dynamically selecting one or more of agent-matching modules, comprising: accessing a request for an agent communication, wherein the request comprises an initial communication comprising a router and a customer communication device, utilized by a customer, via a network; accessing a set of agent-matching modules each agent-matching module of the set of agent-matching modules comprise a logic that differs from each other agent-matching module of the set of agent-matching modules; accessing a system attribute of a system comprising a plurality of agents each having a corresponding agent communication device operable to conduct the agent communication; dynamically selecting a subset of the set of agent-matching modules in accordance with the system attribute; receiving, from the subset of the set of agent-matching modules, a selected agent of the plurality of agents; and establishing the agent communication between the customer communication device and a selected agent communication device corresponding to the selected agent.
A system for dynamically selecting one or more of agent-matching modules, comprising: a network interface to a network; a data storage; a processor coupled with a computer memory comprising computer-readable instructions; a router coupled with the network interface; and wherein the router maintains a connection, via the network, to a customer communication device utilized by a customer, via a network; wherein the processor performs: accessing, from the data storage, a set of agent-matching modules each agent-matching module of the set of agent-matching modules comprise a logic that differs from each other agent-matching module of the set of agent-matching modules; accessing a system attribute of a system comprising a plurality of agents each having a corresponding agent communication device operable to conduct the agent communication; dynamically selecting a subset of the set of agent-matching modules in accordance with the system attribute; receiving, from the subset of the set of agent-matching modules, a selected agent of the plurality of agents; and providing the selected agent of the plurality of agents to the router; and wherein the router routes the agent communication to include a selected agent communication device corresponding to the selected agent.
A router, comprising: a network interface to a network; a processor coupled with a computer memory comprising computer-readable instructions; a router coupled with the network interface; and wherein the router maintains a connection, via the network, to a customer communication device utilized by a customer, via a network; wherein the processor performs: accessing, from the data storage, a set of agent-matching modules each agent-matching module of the set of agent-matching modules comprise a logic that differs from each other agent-matching module of the set of agent-matching modules; accessing a system attribute of a system comprising a plurality of agents each having a corresponding agent communication device operable to conduct the agent communication; dynamically selecting a subset of the set of agent-matching modules in accordance with the system attribute; receiving, from the subset of the set of agent-matching modules, a selected agent of the plurality of agents; and routes the agent communication to include a selected agent communication device corresponding to the selected agent.

A system on a chip (SoC) including any one or more of the above aspects.

One or more means for performing any one or more of the above aspects.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a system in accordance with embodiments of the present disclosure;

FIG. 3 depicts a data processing flow in accordance with embodiments of the present disclosure;

FIG. 4 depicts a data structure in accordance with embodiments of the present disclosure;

FIG. 5 depicts a process in accordance with embodiments of the present disclosure; and

FIG. 6 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

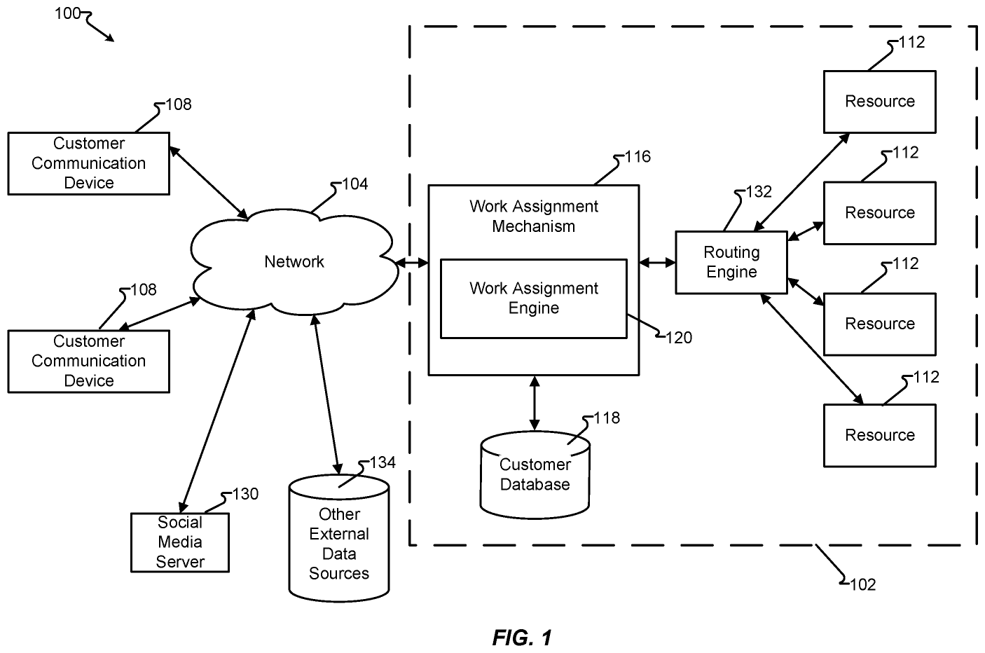

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are themselves, or that are associated with, work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other components may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134, may be within contact center 102 physically and/or logically, but still be considered external for other purposes (e.g., system administration). For example, contact center 102 may operate social media server 130 (e.g., a website operable to receive user messages from customers and/or resources 112) as one means to interact with customers via their customer communication devices 108.

Customer communication devices 108 are embodied as external to contact center 102 as they are under the more direct control of their respective users or customers. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication devices 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through various telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VOIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The customer communication devices 108 may correspond to a particular customer(s). In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resource location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an instant message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed May 20, 2010, Feb. 17, 2010, and Feb. 17, 2010, respectively; each of which is hereby incorporated herein by reference in its entirety.

The format of the work item may depend upon the capabilities of the customer communication device 108 and/or the format of the communication. In particular, work items are logical representations of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At that point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116, or its functionality may be executed by the work assignment engine 120.

In accordance with at least some embodiments of the present disclosure, the customer communication devices 108 may comprise any type of known communication equipment or collection of communication equipment. Examples of a suitable customer communication devices 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent to a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed amongst a plurality of service provider customers, one being contact center 102.

In one embodiment, a message is generated by customer communication device 108 and received via communication network 104 at work assignment mechanism 116. The message received by a contact center 102, such as at the work assignment mechanism 116, is generally, and herein, referred to as a “contact.” Routing engine 132 routes the contact to at least one of resources 112 for processing.

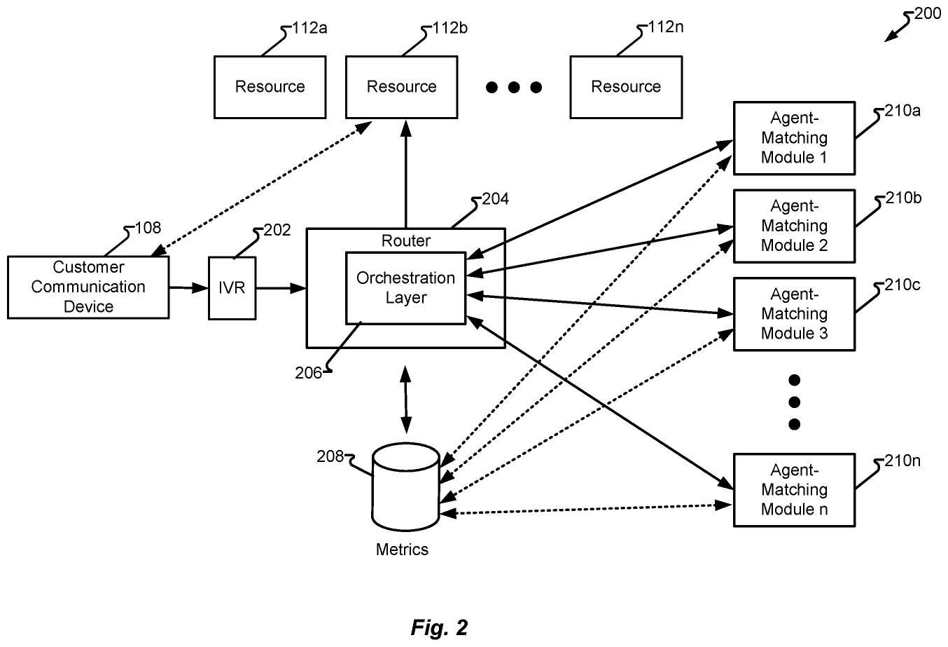

FIG. 2 depicts system 200 in accordance with embodiments of the present disclosure. System 200 omits well-known components, and further omits components previously discussed with respect to system 100 (see FIG. 1), to avoid unnecessarily complicating the figure and associated description. In one embodiment, a customer communication device is utilized by a customer (not shown) to interact with one or more resources 112. The particular resource 112 may be known to the customer, such as a name or extension number for an individual agent utilizing an agent communication device, a category of resources 112 (e.g., an agent in the home mortgage department of a bank, a booking agent in the international flight reservations department of an airline, etc.), or entirely unknown to the customer. When not known, the selection of a particular resource 112 is determined from subsequent processing which may include information gathered from a CRM database and/or customer responses.

The call may be initially processed by router 204, IVR 202, and/or another component utilized to hold the call and optionally obtain a first set of information from the customer. For example, the customer, via IVR 202, may indicate a category of work item, such as the need for technical support and, as a result, router 204 will route the call to connect the customer to a particular resource 112 having the skills to resolve the work item. Resources 112a-112n, when any one or more are embodied as a like agent, utilize an associated agent communication device to communicate with other nodes on an internal network (e.g., databases, other live agents, automated resources, etc.) and/or external nodes, such as customer communication device 108. Resources 112, when any one or more are embodied as an automated agent (e.g., neural network or other artificial intelligence) may be trained in a particular dataset different from another automated resource 112. For example, one automated agent may be trained to resolve customer complaints related to lost luggage whereas another automated agent may be trained to book complicated international flights.

In another embodiment, resource 112 may have skills different from those of other resources 112 that are directed to customer communications, such as a fluency in a particular language, skill level handling irate customers, cultural awareness, etc. Additionally or alternatively, one or more of the agent's skills may be identified as present/absent (e.g., authorized to approve transactions over a particular amount) or scored on a scale (e.g., native Spanish speaker, fluent in French, etc.).

In another embodiment, router 204 may comprise or utilize orchestration layer 206 to select a particular agent-matching module 210 from a set of agent-matching modules 210a-210n. Each agent-matching module 210 has one or more unique data processing and/or data gathering features different from the remaining agent-matching modules 210a-210n. For example, agent-matching module 210a may obtain current occupancy statistics (e.g., queue length, average hold time, agent utilization, etc.) for contact center 102, whereas no other agent-matching module 210 gathers such information. Agent-matching module 210b may gather external information, such as weather information, which may be relevant when contact center 102 is providing customer service for an airline. Additionally or alternatively, one or more of agent-matching modules 210a-210n may be automated and comprise a unique logic, such as a training set provided to a neural network and utilized to gather relevant customer information and/or resolve a work item.

Orchestration layer 206 may determine a single agent-matching module 210 or a set of agent-matching modules 210a-210n to make an agent-matching decision in parallel or in series. For example, agent-matching module 210a may seek to find a best agent (e.g., one of resources 112a-112n) to handle a French-speaking customer in parallel with agent-matching module 210b trained to find a best agent who can handle lost luggage issues. Additionally or alternatively, orchestration layer 206 may select one or more of agent-matching modules 210a-210n in series, wherein one agent-matching module 210 selects one or more resource(s) 112 based on its own logic (including input parameters) and provides the selected resource(s) 112 to a second agent-matching module 210 to select therefrom the best resource 112 based on its logic (including input parameters), such as to avoid consideration of all resources 112 by each selected agent-matching module 210.

In another embodiment, orchestration layer 206 may bind two or more agent-matching modules 210 together, such as to address known situations. For example, if contact center 102 is addressing customer complaints for misrouted luggage for a flight having a number of German-speaking customers, orchestration layer 206 may determine a first subset of agent-matching modules 210 and bind indicia of the selected agent-matching modules 210 together with an index or other indicia to more readily determine which agent-matching module(s) 210 will be tasked with selecting the particular resource 112.

In another embodiment, metrics data storage 208 may comprise metrics for contact center 102 including, but not limited to, overall occupancy, occupancy for a particular skill, success rate, AHT, etc. For example, orchestration layer 206 may select agent-matching module 210a to make an initial selection of a subset from resources 112a-112n and, from that initial selection, agent-matching module 210b makes a final resource 112 selection. However, metrics data storage 208 may indicate that the resulting communication between the final resource 112 selected and the customer had a low success rate, exceptionally long handling time, a high number of calls that required re-routing to a different resource 112, or another indication of a failed match. As a result, metrics data storage 208 may be accessed by orchestration layer 206 to remove or down-weight the selection of agent-matching module 210a and agent-matching module 210b for any similar work items in the future and/or add or up-weight the selection of a different one or more agent-matching module(s) 210.

One or more of agent-matching modules 210 may read and/or write data to metrics data storage 208 as necessary to make or report their decisions. Additionally or alternatively, agent-matching module(s) 210 may report their availability or unavailability to metrics data storage 208, router 204, and/or orchestration layer 206.

Once the selected agent-matching module(s) 210 has selected a particular resource 112, router 204 routes the call to include the resource 112, when automated, or include the corresponding agent communication device when the selected resource 112 is embodied as a live agent. Router 204 may enqueue the call as necessary, when the selected resource 112 is not yet available, and/or route the call to the next available resource 112 when the selected resource 112 is a plurality of resources 112.

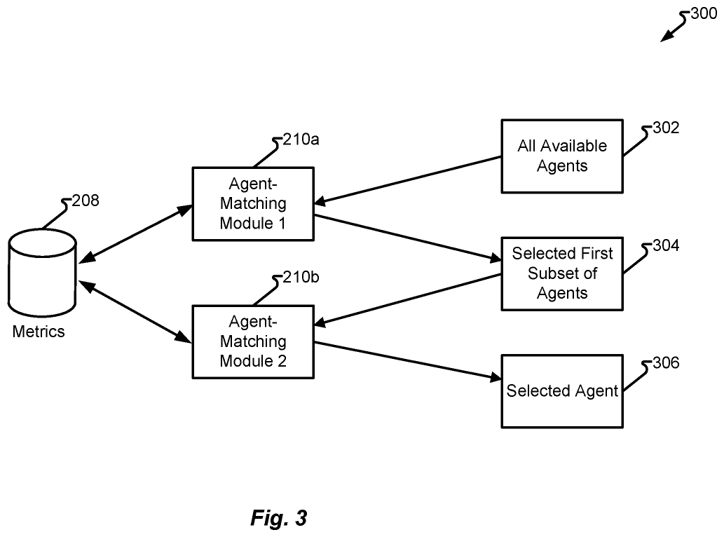

FIG. 3 depicts data processing flow 300 in accordance with embodiments of the present disclosure. Data processing flow 300 is variously embodied including modules further embodied as hardware (e.g., circuitry, data storage components, data processing components, etc.), machine-readable instructions maintained on a non-transitory storage, and/or combinations thereof.

In one embodiment, agent-matching module 210a and agent-matching module 210b are selected by orchestration layer 206 to utilize their logic to make an agent-matching decision wherein customer communication device 108 (see FIGS. 1-2) are connected to a particular resource 112 (Id.). Agent-matching module 210a accesses all available agents 302. All available agents may comprise records maintained in metrics data storage 208, such as identifying live agents and attributes thereof (e.g., skills, success rates, time to resolution, etc.). Agent-matching module 210 may optionally gather additional attributes, such as current attributes/trends of contact center 102 maintained in metrics data storage 208 and/or other sources. Agent-matching module 210a produces a selected first subset of agents 304 which is then provided/accessed by agent-matching module 210b. Agent-matching module 210b may similarly access metrics data storage 208 and/or other sources and, utilizing the logic therein, produce selected agent 306. The selected agent is then provided to router 204 for routing to the corresponding resource 112.

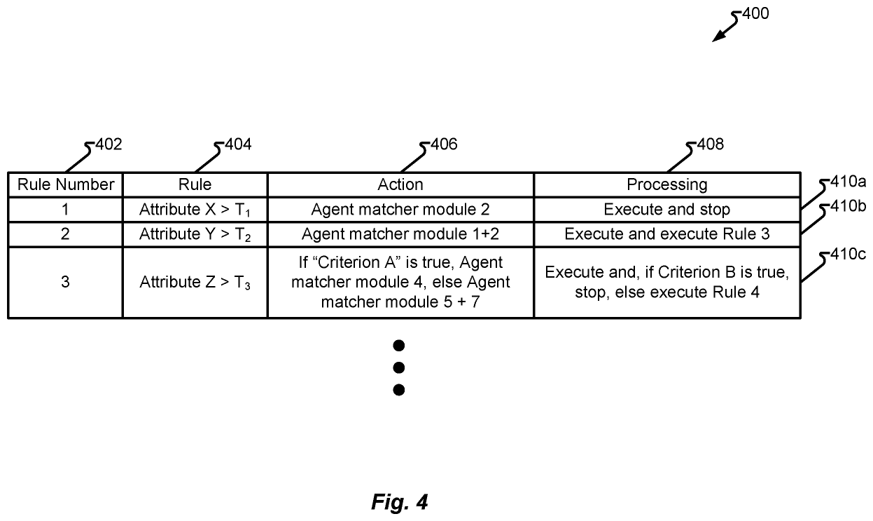

FIG. 4 depicts data structure 400 in accordance with embodiments of the present disclosure. In one embodiment, data structure 400 is maintained in a database, such as metrics data storage 208, and/or other data storage. Data structure 400 comprises a number of records, such as records 410a-410c, each comprising fields 402, 404, 406, 408 and may further include additional fields as a matter of design choice.

Field 402 identifies a rule number, which is evaluated by field 404, and when true causes an action in field 406 to be performed. Field 408 identifies any additional processing, such as any processing actions to take before, during, or after the execution of the action in field 406. Field 402 may be utilized as a binding to associate a particular set of actions (e.g., when field 406 comprises a plurality of agent-matching modules 210 to be executed in parallel or in series).

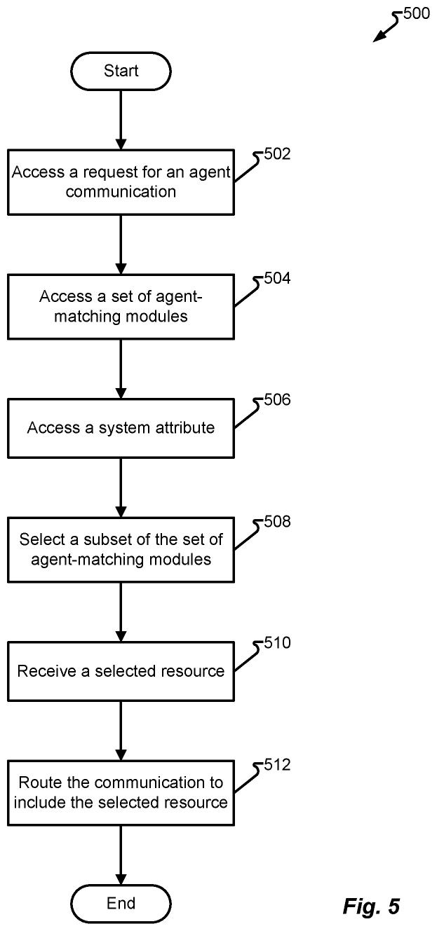

FIG. 5 depicts process 500 in accordance with embodiments of the present disclosure. In one embodiment, process 500 is embodied as machine-readable instructions maintained in a non-transitory media, such as a memory associated with a processor of a hardware component, such as router 204 and/or another processing component. Process 500 begins and, in step 502, a request for an agent communication is accessed. Step 502 may comprise accessing an attribute of a call currently being held by IVR 202 or other component, receiving a notification from router 204, an incoming call notification, and/or indicia of a call to be routed to a particular resource 112 but for which the particular resource 112 has not yet been identified (or connected to the customer communication device 108).

Step 504 accesses a set of agent-matching modules 210, such as via a ping-response to determine each available agent-matching modules 210, accessing a data record of available agent-matching modules 210 in metrics data storage 208, or accessing another data repository having records of available/unavailable agent-matching modules 210. Step 504 may further comprise accessing attributes of available agent-matching modules 210 such as to determine a purpose, type of decision made, etc. for each agent-matching modules 210.

Step 506 accesses at least one system attribute, such as from metrics data storage 208 and/or an external data source. Step 508 selects a subset of the set of agent-matching module(s) 210 to be utilized to make an agent-customer matching decision. Step 508 may access a system attribute of contact center 102, such as one maintained in metrics data storage 208. For example, contact center 102 may be experiencing a peak utilization as indicated by a value of an attribute in metrics data storage 208 or other data source. As a result, orchestration layer 206 selects a particular one or more of agent-matching modules 210 to resolve the work item and to include faster resolution. Conversely, if the system attribute indicated that contact center 102 was well underutilized, orchestration layer 206 may select a particular agent-matching module(s) 210 to provide training to under-skilled agents or otherwise take additional time to resolve the work item. Step 508 may select indicia of one or more agent-matching module(s) 210 bound together, such as to make a routing decision previously encountered.

The selected agent-matching module(s) 210 are signaled to perform the decision. The signaling may include providing the selected agent-matching module(s) 210 with indicia or attribute(s) of a call, customer, etc. or simply signaling to begin, wherein the selected agent-matching module(s) 210 obtains information needed from metrics data storage 208 and/or other data storage. Step 510 then receives a selected resource which is then utilized to connect the customer, via their corresponding customer communication device 108, to the selected resource 112. Step 512 then routes the communication to include the selected resource 112. The process 500 then ends and may be repeated for additional communications.

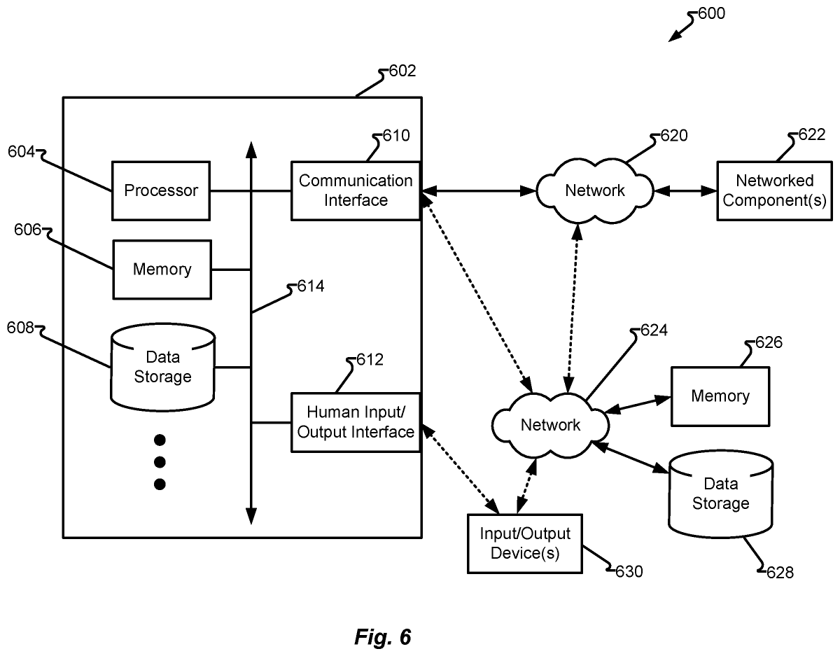

FIG. 6 depicts device 602 in system 600 in accordance with embodiments of the present disclosure. In one embodiment, router 204 may be embodied, in whole or in part, as device 602 comprising various components and connections to other components and/or systems. The components are variously embodied and may comprise processor 604. The term “processor,” as used herein, refers exclusively to electronic hardware components comprising electrical circuitry with connections (e.g., pin-outs) to convey encoded electrical signals to and from the electrical circuitry. Processor 604 may comprise programmable logic functionality, such as determined, at least in part, from accessing machine-readable instructions maintained in a non-transitory data storage, which may be embodied as circuitry, on-chip read-only memory, computer memory 606, data storage 608, etc., that cause the processor 604 to perform the steps of the instructions. Processor 604 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 614, executes instructions, and outputs data, again such as via bus 614. In other embodiments, processor 604 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 604 is a non-transitory computing device (e.g., electronic machine comprising circuitry and connections to communicate with other components and devices). Processor 604 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 604). Processor 604 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 604, device 602 may utilize computer memory 606 and/or data storage 608 for the storage of accessible data, such as instructions, values, etc. Communication interface 610 facilitates communication with components, such as processor 604 via bus 614 with components not accessible via bus 614. Communication interface 610 may be embodied as a network port, card, cable, or other configured hardware device. Additionally or alternatively, human input/output interface 612 connects to one or more interface components to receive and/or present information (e.g., instructions, data, values, etc.) to and/or from a human and/or electronic device. Examples of input/output devices 630 that may be connected to input/output interface include, but are not limited to, keyboard, mouse, trackball, printers, displays, sensor, switch, relay, speaker, microphone, still and/or video camera, etc. In another embodiment, communication interface 610 may comprise, or be comprised by, human input/output interface 612. Communication interface 610 may be configured to communicate directly with a networked component or configured to utilize one or more networks, such as network 620 and/or network 624.

Network 104 may be embodied, in whole or in part, as network 620. Network 620 may be a wired network (e.g., Ethernet), wireless (e.g., WiFi, Bluetooth, cellular, etc.) network, or combination thereof and enable device 602 to communicate with networked component(s) 622. In other embodiments, network 620 may be embodied, in whole or in part, as a telephony network (e.g., public switched telephone network (PSTN), private branch exchange (PBX), cellular telephony network, etc.).

Additionally or alternatively, one or more other networks may be utilized. For example, network 624 may represent a second network, which may facilitate communication with components utilized by device 602. For example, network 624 may be an internal network to a business entity or other organization, such as contact center 102, whereby components are trusted (or at least more so) than networked components 622, which may be connected to network 620 comprising a public network (e.g., Internet) that may not be as trusted.

Components attached to network 624 may include computer memory 626, data storage 628, input/output device(s) 630, and/or other components that may be accessible to processor 604. For example, computer memory 626 and/or data storage 628 may supplement or supplant computer memory 606 and/or data storage 608 entirely or for a particular task or purpose. As another example, computer memory 626 and/or data storage 628 may be an external data repository (e.g., server farm, array, “cloud,” etc.) and enable device 602, and/or other devices, to access data thereon. Similarly, input/output device(s) 630 may be accessed by processor 604 via human input/output interface 612 and/or via communication interface 610 either directly, via network 624, via network 620 alone (not shown), or via networks 624 and 620. Each of computer memory 606, data storage 608, computer memory 626, data storage 628 comprise a non-transitory data storage comprising a data storage device.

It should be appreciated that computer-readable data may be sent, received, stored, processed, and presented by a variety of components. It should also be appreciated that components illustrated may control other components, whether illustrated herein or otherwise. For example, one input/output device 630 may be a router, a switch, a port, or other communication component such that a particular output of processor 604 enables (or disables) input/output device 630, which may be associated with network 620 and/or network 624, to allow (or disallow) communications between two or more nodes on network 620 and/or network 624. For example, a connection between one particular customer, using a particular customer communication device 108, may be enabled (or disabled) with a particular networked component 622 and/or particular resource 112. Similarly, one particular networked component 622 and/or resource 112 may be enabled (or disabled) from communicating with a particular other networked component 622 and/or resource 112, including, in certain embodiments, device 602 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for dynamically selecting one or more agent-matching modules, comprising:
accessing a request for an agent communication, wherein the request comprises an initial communication comprising a router and a customer communication device utilized by a customer via a network;
accessing a set of agent-matching modules, each agent-matching module of the set of agent-matching modules comprising a logic that differs from each other agent-matching module of the set of agent-matching modules;
accessing a system attribute of a system comprising a plurality of agents, each having a corresponding agent communication device operable to conduct the agent communication;
dynamically selecting a subset of the set of agent-matching modules in accordance with the system attribute;
receiving, from the subset of the set of agent-matching modules, a selected agent of the plurality of agents; and
establishing the agent communication between the customer communication device and a selected agent communication device corresponding to the selected agent.

2. The method of claim 1, wherein the system attribute comprises at least one of average handle time, average wait time, system utilization, component utilization of a component of the system, or communication resolution success rate.

3. The method of claim 1, wherein the system attribute comprises an occupancy level, utilization rate, number of pending communication requests, or queue size for the one or more agent-matching modules of the set of agent-matching modules.

4. The method of claim 1, wherein:
dynamically selecting the subset of the set of agent-matching modules in accordance with the system attribute further comprises selecting a first agent-matching module of the set of agent-matching modules and selecting a second agent-matching module of the set of agent-matching modules;
receiving, from the subset of the set of agent-matching modules, the selected agent of the plurality of agents further comprises receiving from the first agent-matching module a first subset of agents; and
the method further comprises providing the first subset of agents to the second agent-matching module and receiving therefrom the selected agent of the plurality of agents.

5. The method of claim 1, wherein:
dynamically selecting the subset of the set of agent-matching modules in accordance with the system attribute further comprises selecting a first agent-matching module of the set of agent-matching modules and selecting a second agent-matching module of the set of agent-matching modules; and
receiving, from the subset of the set of agent-matching modules, the selected agent of the plurality of agents further comprises receiving from the first agent-matching module a first subset of agents and receiving from the second agent-matching module a second subset of agents, wherein the selected agent is a member of both the first subset of agents and the second subset of agents.

6. The method of claim 1, wherein dynamically selecting the subset of the set of agent-matching modules in accordance with the system attribute further comprises selecting an identifier corresponding to the subset of the set of agent-matching modules in accordance with the system attribute.

7. The method of claim 1, further comprising:
accessing an attribute of the request; and
wherein dynamically selecting the subset of the set of agent-matching modules in accordance with the system attribute further comprises dynamically selecting the subset of the set of agent-matching modules in accordance with the attribute of the request.

8. The method of claim 1, wherein accessing the set of agent-matching modules comprises accessing indicia of the set of agent-matching modules.

9. A system for dynamically selecting one or more agent-matching modules, comprising:
a network interface to a network;
a data storage;
a processor coupled with a computer memory comprising computer-readable instructions; and
a router coupled with the network interface; and
wherein the router maintains a connection, via the network, to a customer communication device utilized by a customer;
wherein the processor performs:
accessing, from the data storage, a set of agent-matching modules, each agent-matching module of the set of agent-matching modules comprising a logic that differs from each other agent-matching module of the set of agent-matching modules;
accessing a system attribute of the system comprising a plurality of agents, each having a corresponding agent communication device operable to conduct the communication;
dynamically selecting a subset of the set of agent-matching modules in accordance with the system attribute;
receiving, from the subset of the set of agent-matching modules, a selected agent of the plurality of agents; and
providing the selected agent of the plurality of agents to the router; and
wherein the router routes the agent communication to include a selected agent communication device corresponding to the selected agent.

10. The system of claim 9, wherein the system attribute comprises at least one of average handle time, average wait time, system utilization, component utilization of a component of the system, or communication resolution success rate.

11. The system of claim 9, wherein the system attribute comprises an occupancy level, utilization rate, number of pending communication requests, or queue size for the one or more agent-matching modules of the set of agent-matching modules.

12. The system of claim 9, wherein the processor performs:
dynamically selecting the subset of the set of agent-matching modules in accordance with the system attribute, further comprising selecting a first agent-matching module of the set of agent-matching modules and selecting a second agent-matching module of the set of agent-matching modules;
receiving, from the subset of the set of agent-matching modules, the selected agent of the plurality of agents, further comprising receiving from the first agent-matching module a first subset of agents; and
providing the first subset of agents to the second agent-matching module and receiving therefrom the selected agent of the plurality of agents.

13. The system of claim 9, wherein the processor performs:
dynamically selecting the subset of the set of agent-matching modules in accordance with the system attribute, further comprising selecting a first agent-matching module of the set of agent-matching modules and selecting a second agent-matching module of the set of agent-matching modules; and
receiving, from the subset of the set of agent-matching modules, the selected agent of the plurality of agents, further comprising receiving from the first agent-matching module a first subset of agents and receiving from the second agent-matching module a second subset of agents, wherein the selected agent is a member of both the first subset of agents and the second subset of agents.

14. The system of claim 9, wherein the processor performs dynamically selecting the subset of the set of agent-matching modules in accordance with the system attribute, further comprising selecting an identifier corresponding to the subset of the set of agent-matching modules in accordance with the system attribute.

15. The system of claim 9, wherein the processor is co-embodied with the router.

16. A router, comprising:
a network interface to a network;
a processor coupled with a computer memory comprising computer-readable instructions; and
the router coupled with the network interface;
wherein the router maintains a connection, via the network, to a customer communication device utilized by a customer; and
wherein the processor performs:
accessing, from a data storage, a set of agent-matching modules, each agent-matching module of the set of agent-matching modules comprising a logic that differs from each other agent-matching module of the set of agent-matching modules;
accessing a system attribute of a system comprising a plurality of agents, each having a corresponding agent communication device operable to conduct the communication;
dynamically selecting a subset of the set of agent-matching modules in accordance with the system attribute;
receiving, from the subset of the set of agent-matching modules, a selected agent of the plurality of agents; and
routing the agent communication to include a selected agent communication device corresponding to the selected agent.

17. The router of claim 16, wherein the system attribute comprises at least one of average handle time, average wait time, system utilization, component utilization of a component of the system, or communication resolution success rate.

18. The router of claim 16, wherein the system attribute comprises an occupancy level, utilization rate, number of pending communication requests, or queue size for one or more agent-matching modules of the set of agent-matching modules.

19. The router of claim 16, wherein:
dynamically selecting the subset of the set of agent-matching modules in accordance with the system attribute further comprises selecting a first agent-matching module of the set of agent-matching modules and selecting a second agent-matching module of the set of agent-matching modules;
receiving, from the subset of the set of agent-matching modules, the selected agent of the plurality of agents further comprises receiving from the first agent-matching module a first subset of agents; and
the router further comprises providing the first subset of agents to the second agent-matching module and receiving therefrom the selected agent of the plurality of agents.

20. The router of claim 16, wherein:
dynamically selecting the subset of the set of agent-matching modules in accordance with the system attribute further comprises selecting a first agent-matching module of the set of agent-matching modules and selecting a second agent-matching module of the set of agent-matching modules; and
receiving, from the subset of the set of agent-matching modules, the selected agent of the plurality of agents further comprises receiving from the first agent-matching module a first subset of agents and receiving from the second agent-matching module a second subset of agents, wherein the selected agent is a member of both the first subset of agents and the second subset of agents.
